(19) United States
(12) Patent Application Publication
(10) Pub. No.: US 2008/0023884 A1
(43) Pub. Date: Jan. 31, 2008

(54) Method for preparing poly(dicyclopentadiene)

(75) Inventors: Wayde V. Konze, Midland, MI (US); David H. Bank, Midland, MI (US); Martin C. Cornell, Lake Jackson, TX (US); Zenon Z. Lysenko, Midland, MI (US); Francis J. Timmers, Midland, MI (US)

Correspondence Address: THE DOW CHEMICAL COMPANY;GARY C. COHN, 1147 NORTH FORTH ST., UNIT 6-E, PHILADELPHIA, PA, 19123, US

(73) Assignee: Dow Global Technologies Inc.

(21) Appl. No.: 11/879,120

(22) Filed: Jul. 16, 2007

Related U.S. Application Data
(60) Provisional application No. 60/831,890, filed on Jul. 18, 2006.

(51) Int. Cl. B29C 45/03; C08G 61/08

(52) U.S. Cl. 264/328.1; 525/326.5; 525/326.8; 525/329.5; 525/332.1; 526/336

(57) ABSTRACT

Crosslinked polydicyclopentadiene polymer and copolymer are made by first forming a thermoplastic polymeric intermediate in a ring-opening metathesis polymerization (ROMP), and then crosslinking the intermediate in a melt-processing or solution processing step. The formation of the intermediate permits facile removal of residual monomer, which leads to a reduction in odor and improvement in physical properties. Crosslinking can be achieved using various crosslinking strategies, including further ROMP reactions, addition polymerization of residual double bonds, addition of a crosslinking agent or introduction of functional groups.

### CROSS-REFERENCE TO RELATED APPLICATIONS

This application claims benefit of U.S. Provisional Patent Application No. 60/831,890, filed 18 Jul. 2006.

### BACKGROUND OF THE INVENTION

This invention relates to processes for polymerizing dicyclopentadiene.

Dicyclopentadiene can be polymerized though what is often called a “ring opening metathesis polymerization”, or “ROMP”. Given proper temperature and catalyst conditions, dicyclopentadiene can polymerize very rapidly. The metathesis reaction involves a rupture of a ring double bond with formation of unsaturated linkages to adjacent monomer units, as represented by the following idealized reaction scheme:

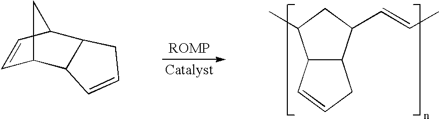

Enough crosslinking occurs during the polymerization reaction that a thermoset polymer is obtained. The crosslinking may be due to a second metathesis reaction at the site of the less reactive cyclopentene ring. A possible alternative mechanism is that crosslinking occurs due to addition polymerization of the pendant cyclopentene groups.

A common type of catalyst for these polymerizations includes a tungsten procatalyst and an activator (such as an organo-aluminum compound). The two-part catalyst system lends itself to reaction injection molding polymerization methods, in which a monomer stream containing the procatalyst is brought into contact with a second monomer stream that contains the activator.

These conventional types of catalysts are very sensitive to polar impurities (of which water is a notable example). Even very small quantities of polar impurities can lead to incomplete conversion of monomers to polymer. Very high catalyst loadings can compensate for this, but often at the cost of sensitivity to sunlight and embrittlement of the polymer.

Incomplete conversion of monomer to polymer can compromise polymer physical properties. However, incomplete conversion is more troublesome in dicyclopentadiene polymerizations than in other systems because the monomer has a strong, objectionable odor. When the conversion to polymer is incomplete, the odor problem carries over to the polymerized product, and limits its applications. Polydicyclopentadiene polymers are used mainly in outdoor applications, such as truck body panels and lawn mower shrouds, where dicyclopentadiene odors cannot accumulate. It is very difficult to remove residual monomer from the polymer, and doing so adds significant costs.

It would be desirable to provide a more flexible process for producing polydicyclopentadiene polymers. In particular, it would be desirable to produce polydicyclopentadiene articles using melt-processing methods similar to those used to process thermoplastic resins. It would further be desirable to provide a polymerization process whereby low odor polydicyclopentadiene resins could be prepared easily, without need to post-treat the polymer to remove residual monomers.

### SUMMARY OF THE INVENTION

This invention is a process comprising melting a thermoplastic, solid dicyclopentadiene polymer or copolymer and crosslinking the dicyclopentadiene polymer or copolymer in the melt to form a crosslinked polymer having a gel content of at least 35%.

This invention is also a process for preparing dicyclopentadiene polymers, comprising (a) forming a reaction mixture containing (1) at least one thermoplastic polymer or copolymer of dicyclopentadiene and (2) at least one crosslinking agent, and (b) subjecting the reaction mixture to conditions sufficient to crosslink the thermoplastic polymer or copolymer.

This process is amenable to use with a wide variety of polymer processing methods. The process can be practiced using melt-processing methods, such as reactive extrusion and injection molding, which are more typically used in conjunction with thermoplastics processing. The process can also be practiced using techniques that are conventionally used for thermoset resin processing, such as reaction injection molding or resin transfer molding. Very low odor products are obtained, because the residual monomer content of the starting polymers is low. Starting polymers having low residual monomer content can be prepared easily using simple purification techniques.

Similarly, a range of crosslinking methods can be used to accomplish the crosslinking step, leading to a versatile process that can be adapted to a range of processing conditions and product requirements.

In another aspect, this invention is a process for preparing a thermoplastic polymer or copolymer of dicyclopentadiene, comprising subjecting dicyclopentadiene monomer or a monomer mixture of dicyclopentadiene and at least one other cyclic olefin, a polymerization catalyst and at least 0.03 moles of a chain transfer agent per mole of monomer or monomers to conditions sufficient to polymerize the monomer or monomers to form a thermoplastic polymer.

In still another aspect, this invention is a process for preparing a polydicyclopentadiene polymer or copolymer, comprising subjecting a previously formed, crosslinkable polydicyclopentadiene starting polymer or copolymer having a number average molecular weight of from 1000 to 50,000 to conditions sufficient to crosslink the polydicyclopentadiene polymer.

In another aspect, this invention is a process comprising (a) polymerizing dicyclopentadiene to form a thermoplastic polymer having a number average molecular weight of from 1000 to 50,000, (b) reducing the residual monomer content of the polymer to less than 1000 ppm, and then (c) crosslinking the polymer.

In yet another aspect, this invention is a thermoplastic dicyclopentadiene polymer, wherein the dicyclopentadiene polymer is a homopolymers of dicyclopentadiene or a copolymer of at least 75 mole percent dicyclopentadiene and up to 25 mole percent of at least one other cyclic olefin, the thermoplastic dicyclopentadiene polymer having a number average molecular weight of from 1,000 to 50,000 and a residual monomer content of no more than 100 ppm.

### DETAILED DESCRIPTION OF THE INVENTION

The invention can be used to form polymers of dicyclopentadiene. The polymers can be homopolymers of dicyclopentadiene, or a copolymer of dicyclopentadiene with a variety of other cyclic olefins, such as cyclobutene, cyclopentene, cycloheptene, cyclooctene, cyclononene, cyclodecene, cyclododecene, norbornene, cyclooctadiene, cyclononadiene, norbornadiene, 7-oxanorbornadiene and the like. Dicyclopentadiene should constitute at least 50 mole percent, preferably at least 75 mole percent, of the monomers.

A thermoplastic starting polymer of the cyclic olefin is prepared and used as a starting material in the process of the invention. By “thermoplastic”, it is meant that the polymer is melt-processable at some temperature below its degradation temperature, and so can be formed into shaped parts through a melt-processing method. The starting polymer may include branched species or gels provided that it remains melt-processable. The starting polymer is preferably characterized by having a low gel content. Gels are insoluble crosslinked species. The gel content of the starting polymer is preferably less than 15% by weight, more preferably is less than 5% by weight and even more preferably no more than 1% by weight. The starting polymer most preferably contains no more than 0.5% by weight of gels. Gel content in the starting polymer can be determined using optical methods by forming a thin film of the starting polymer and counting the number of gel particles.

The molecular weight of the starting polymer can vary quite widely, provided that the polymer is solid at room temperature (˜22° C.) and is thermoplastic. For example, the number average molecular weight (Mn) of the starting polymer may be as low as about 1000, or as high as 50,000 or more. The molecular weight of the starting polymer is generally not critical, provided that the starting polymer can be melt processed at reasonable temperatures. The molecular weight of the starting polymer can, however, play a role in final product properties. Lower molecular weight starting polymers generally need to be more highly crosslinked during the crosslinking step in order to build molecular weight, and for that reason tend to form more densely crosslinked polymers. As a result, lower molecular weight starting polymers tend to form more rigid and friable products. Lower molecular weight starting polymers (such as those with an Mₙ of 1,000 to 10,000) also tend to have lower melt viscosities, and thus may be suitable for use in processing equipment (such as resin transfer molding or reaction injection molding equipment) in which lower viscosity materials are suitable. Higher molecular weight polymers (having an Mₙ of >10,000, especially >20,000) usually do not need to be crosslinked as much to build molecular weight and achieve desirable properties, and thus tend to form tougher and less friable products during the crosslinking step. They also tend to have higher melt viscosities and are used more easily in melt-processing operations that are adapted for thermoplastics processing, such as reactive extrusion or injection molding.

The starting polymer is conveniently prepared by polymerizing the monomer(s) in the presence of a ROMP polymerization catalyst. Crosslinking reactions can be largely prevented through the selection of a catalyst which does not strongly promote addition polymerization or the metathesis of the less-reactive of the two cyclic carbon-carbon double bonds in the dicyclopentadiene monomer. The presence of a chain transfer agent also helps to control crosslinking and molecular weight. Milder reaction conditions also can help reduce the amount of crosslinking that occurs. Crosslinking can also be suppressed by conducting the polymerization in a somewhat dilute solution.

Useful polymerization catalysts include various tungsten, molybdenum, rhenium, ruthenium or tantalum compounds. Suitable catalyst systems include molybdenum catalysts as described in U.S. Pat. No. 6,433,113; ReCl₅/Me₄Sn systems as described by Pacreau and Fontanille in Makromol. Chem. 1987, 188, 2585-2595; molybdenum carbene catalysts as described by Davidson and Wagener in J. Molecular Catalysis A: Chemical 1998, 133, 67-74; and allyl silane/tungsten catalysts as described by Dimonie et al., in NATO Science Series, II: Mathematics, Physics and Chemistry 2002, 6465-6476. Tungsten and molybdenum catalysts in which the tungsten or molybdenum atom has an oxidation state of +VI are particularly useful. Examples of such compounds include tungsten hexachloride, tungsten oxychloride, and the so-called “Schrock” catalyst, which is represented by the structure: 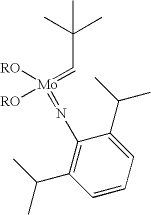
Ruthenium compounds such as the so-called “Grubbs” catalysts (as described more below) tend to be less preferred as it is difficult to control crosslinking reactions using such catalysts.

The amount of catalyst is selected to provide an economically reasonable reaction rate. Excess amounts that strongly promote crosslinking reactions should be avoided. The amount of catalyst will depend to some extent on the particular catalyst that is selected, the particular monomer mixture to be polymerized, and other reaction parameters. Generally, about 0.00001 to 0.10 mole of catalyst are used per mole of monomer(s). A preferred amount of catalyst is from 0.00005 to 0.001 mole of catalyst per mole of monomer(s).

The catalyst may be used in conjunction with an activator compound such as an organo-aluminum compound, a Lewis acid, an allylsilane compound or an acyclic diene. The allyl silane and acyclic diene compounds can also function as chain transfer agents during the polymerization reaction, controlling molecular weight and suppressing crosslinking reactions.

A chain transfer agent is preferably present during the polymerization of the starting polymer. Suitable chain transfer agents include olefin-substituted silanes, alpha-olefins and acyclic dienes. Examples of olefin-substituted silanes include, for example, tetraallyl silane, triallylmethyl silane, diallyldimethyl silane, allyltrimethyl silane and the like. Suitable alpha-olefin chain transfer agents include ethylene, propylene, 1-butene, 1-pentene, 1-hexene, 1-octene, 1-decene, 1-docecene and substituted derivatives thereof. Suitable dienes include butadiene, 1,4-pentadiene, 1,5-hexadiene, 1,6-heptadiene, 1,7-octadiene and the like.

As the chain transfer agent has a strong effect on the polymer molecular weight, the amount of chain transfer agent that is used is selected at least in part based on the desired molecular weight of the starting polymer that is to be produced. From 0.001 to 0.1 moles of chain transfer agent can be used per mole of monomer(s). A preferred amount of chain transfer agent is from 0.005 to 0.1 mole/mole of monomer(s), and a particularly preferred amount is from 0.03 to 0.1 mole/mole of monomer(s).

The polymerization reaction is preferably performed in the presence of a solvent or diluent. Suitable solvents are compounds in which the monomer(s) and polymer are soluble. The catalyst and chain transfer agent are also preferably soluble in the solvent. The solvent should also be non-reactive under the conditions of the polymerization reaction. Suitable solvents include non-polymerizable hydrocarbons, halogenated hydrocarbons, ethers, ketones and the like. A preferred solvent is toluene. A suitable diluent is a material that does not dissolve the monomer(s) and polymer, but is non-reactive under the conditions of the polymerization reaction.

Somewhat dilute conditions tend to disfavor the occurrence of crosslinking reactions and are favored for that reason. The concentration of monomer(s) plus dissolved polymer product in the reaction mixture is suitably from about 1 to 75% by weight, preferably from 2 to 50% by weight and more preferably from 5 to 25% by weight.

The polymerization is conducted by bringing the monomer, catalyst (and activator, if any), chain transfer agent and solvent or diluent (if any) together under polymerization conditions. The polymerization typically proceeds well under mild conditions. Thus, the polymerization temperature may be any temperature up to the cracking temperature of the monomer(s), but a more suitable polymerization temperature is from 0 to 60° C., preferably from 10 to 40° C. Higher polymerization temperatures can be used, but it is usually not necessary from the standpoint of achieving reasonable polymerization rates, and entails the risk of forming excessive quantities of crosslinked species.

Residual monomer is removed from the resulting polymer. The polymer thus formed is thermoplastic (i.e., fusible) and is most often soluble in some solvent. Therefore, residual monomer can be removed from the polymer readily using a variety of solvent extraction and devolatilization methods. Enough of the residual monomer is removed to from a low odor product. Residual monomer can be removed to a level of no greater than 1,000 ppm, preferably no greater than 100 ppm, more preferably no greater than 10 ppm (or any lower value as is desired), in order to reduce or eliminate objectionable odor in the polymer.

It may also be desirable to remove residual catalyst or catalyst decomposition products from the starting polymer.

The resulting starting polymer can be crosslinked to form a wide variety of products. The crosslinking can be done in a melt-processing step or in solution. Because the starting polymer is substantially free of residual monomer, neither it nor the crosslinked product has the odor problems that are associated with dicyclopentadiene polymers. Therefore, it is usually unnecessary to employ abatement measures to combat odor problems during the melt-processing and crosslinking steps. Because the products do not contain residual monomer in significant quantities, they can be used in a much wider range of applications, including indoor applications for which previous cyclic olefin polymers have been found unsuitable due to the odor issue.

A variety of crosslinking mechanisms can be used to crosslink the starting polymer. Illustrative approaches include 1) crosslinking through further reaction of carbon-carbon double bonds on the starting polymer, 2) crosslinking through the addition of a crosslinking agent and/or 3) crosslinking through heteroatom-containing functional groups that are present in or introduced onto the starting polymer, with or without the addition of a separate cross-linking agent.

In crosslinking approach 1), the further reactions can include addition polymerization of the double bonds that are present in cyclopentene groups on the polymer or in the main polymer chain. Cyclopentene groups can also form crosslinks by engaging in further ring-opening metathesis reactions. These crosslinking reactions can be promoted through the use of appropriate initiator and/or catalyst compounds, in particular free radical initiators (in the case of addition polymerization), and catalysts for the ROMP reaction.

Free radical initiators suitable for promoting the addition polymerization of carbon-carbon double bonds are well-known, and include a variety of peroxy compounds such as peroxides, peroxyesters and peroxycarbonates. Examples of suitable organic peroxy compounds include t-butyl peroxyisopropylcarbonate, t-butyl peroxylaurate, 2,5-dimethyl-2,5-di(benzoyloxy)hexane, t-butyl peroxyacetate, di-t-butyl diperoxyphthalate, t-butyl peroxymaleic acid, cyclohexanone peroxide, t-butyl diperoxybenzoate, dicumyl peroxide, 2,5-dimethyl-2,5-di(t-butylperoxy)hexane, t-butylcumyl peroxide, t-butyl hydroperoxide, di-t-butyl peroxide, 1,3-di(t-butylperoxyisopropyl) benzene, 2,5-dimethyl-2,5-di-t-butylperoxy)-hexyne-3, di-isopropylbenzene hydroperoxide, p-methane hydroperoxide and 2,5-dimethylhexane-2,5-dihydroperoxide. A preferred quantity of organic peroxy crosslinkers is from 0.5 to 5 percent of the weight of the starting polymer. The amount of peroxy crosslinker that is used will affect the amount of crosslinking that is obtained, and so can be manipulated as desired to obtain a desired crosslink density in the product

ROMP catalysts that are useful in the crosslinking reaction include those described before with respect to the polymerization of the starting polymer. In addition, stronger ROMP catalysts such as the so-called Grubbs catalysts, as described by Grubbs et al. in JACS 1997, 119, 3887-3897, Grubbs et al. in Org. Lett., 1999, 1, 953-956 and Hoveyda et al., in JACS 2000, 122, 8168-8179. Examples of suitable Grubbs catalysts have the structures: 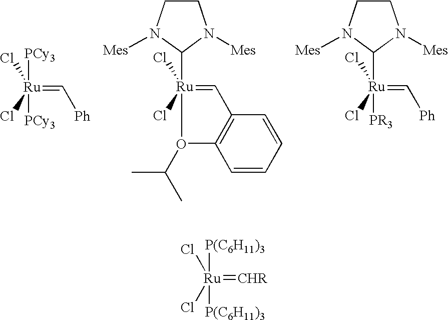
Amounts of the ROMP catalyst can be as described before, although somewhat greater amounts also can be used if desired to speed the reaction rate or increase the amount of crosslinking.

Other catalysts for the addition polymerization of carbon-carbon double bonds can also be used in the crosslinking reaction, such as Zeigler-Natta catalysts and metallocene catalysts.

A second method of crosslinking the starting polymer is through the inclusion of a crosslinking agent during the melt-processing step. A suitable crosslinking agent is a material which can react with two or more molecules of the starting polymer to form a covalent bond directly or indirectly (i.e., though some linking group) between the two polymer chains.

A wide variety of such crosslinking agents are useful, including, for example, peroxy compounds as described before, poly(sulfonyl azides), furoxans, triazolinediones, dichloromaleimide, azides, aldehyde-amine reaction products, substituted ureas, substituted guanidines, substituted xanthates, substituted dithiocarbamates, sulfur-containing compounds such as thiazoles, imidazoles, sulfenamides, thiuramidisulfides, paraquinonedioxime, dibenzoparaquinonedioxime, sulfur and the like. Suitable crosslinkers of many of these types are described in U.S. Pat. No. 5,869,591. In addition, compounds having two or more 2,2,6,6-tetramethyl piperidinyloxy (TEMPO) groups or derivatives of such groups are useful, as are compounds having two or more allyl or vinyl groups/molecule.

Another type of crosslinking agent is a compound that is readily susceptible to Friedel-Crafts alkylation reactions at multiple sites. Phenols and bisphenols are notable examples of this type of crosslinking agent.

Crosslinking agents of particular note are the poly(sulfonyl azides), furoxans and compounds such as phenols or bisphenols which are readily susceptible to Freidel-Crafts alkylations at multiple sites.

Suitable poly(sulfonyl azide) crosslinkers are compounds having at least two sulfonyl azide (—SO₂N₃) groups per molecule. Such poly(sulfonyl azide) crosslinkers are described, for example, in WO 02/068530. Examples of suitable poly(sulfonyl azide) crosslinkers include 1,5-pentane bis(sulfonyl azide), 1,8-octane bis(sulfonyl azide), 1,10-decane bis(sulfonyl azide), 1,18-octadecane bis(sulfonyl azide), 1-octyl-2,4,6-benzene tris(sulfonyl azide), 4,4′-diphenyl ether bis(sulfonyl azide), 1,6-bis (4′-sulfonazidophenyl)hexane, 2,7-naphthalene bis(sulfonyl azide), oxy-bis(4-sulfonylazido benzene), 4,4′-bis(sulfonyl azido)biphenyl, bis(4-sulfonylazidophenyl)methane and mixed sulfonyl azides of chlorinated aliphatic hydrocarbons that contain an average of from 1 to 8 chlorine atoms and from 2 to 5 sulfonyl azide groups per molecule.

Poly(sulfonyl azide) crosslinking can be illustrated by the following idealized reaction scheme involving, in this instance, a linear polydicyclopentadiene starting polymer:

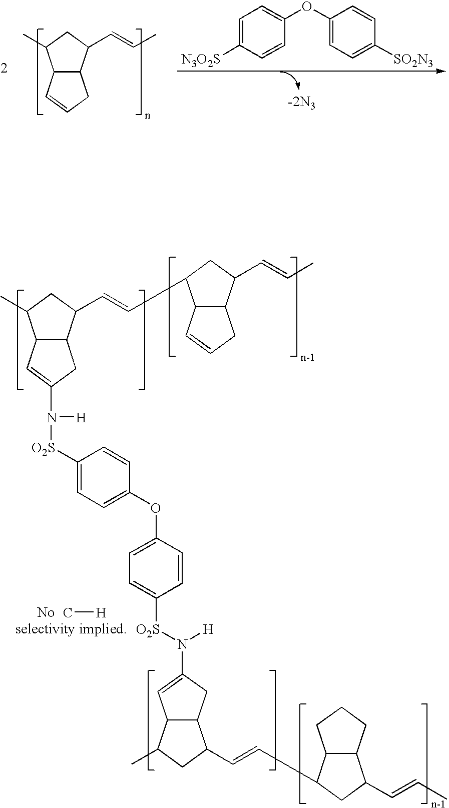

Furoxan crosslinkers are believed to ring-open to form dinitrile oxides, which in turn can react with carbon-carbon double bonds on the starting polymer in a 3+2 reaction to generate isoxazoline rings. This reaction is shown schematically as follows, again for purposes of illustration using a linear polydicyclopentadiene as a starting material:

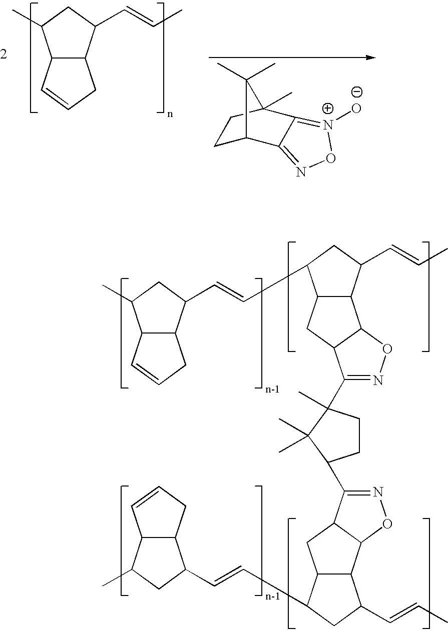

Compounds that are readily alkylated, such as phenols and bisphenols, can form crosslinks via a Lewis acid-assisted Friedel-Crafts alkylation. In the case of phenols and bisphenols, alkylation occurs at the aromatic ring. The alkylated compound (the phenolic ring structure in the case of phenols or bisphenols) therefore forms the crosslink, as illustrated in the following idealized reaction scheme, where once again a polydicyclopentadiene is shown as the starting polymer:

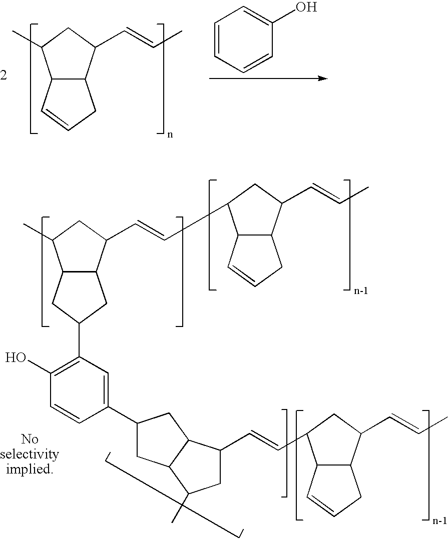

Suitable polynitroxyl compounds are bis(l-oxyl-2,2,6,6-tetramethylpiperadine-4-yl)sebacate, di-t-butyl N oxyl, dimethyl diphenylpyrrolidine-1-oxyl, 4-phosphonoxy TEMPO or a metal complex with TEMPO.

Compounds having two or more vinyl or allyl groups per molecule that are useful as crosslinkers include allyl acrylate, allyl methacrylate, divinylbenzene, triallyl cyanurate, triallyl isocyanurate, triallylmellitate and triallylsilane compounds.

In the third approach to crosslinking the polymer, heteroatom-containing functional groups are introduced to the starting polymer. The functional groups react with each other, different types of functional groups on the starting polymer, or with a separate crosslinking agent to form crosslinks. Suitable functional groups contain oxygen and/or nitrogen atoms, and include hydroxyl, isocyanate, epoxide, isocyanate, carboxylic acid, carboxylic acid anhydride, primary or secondary amino, hydrolyzable silane or similar groups.

Such functional groups can be introduced onto the starting polymer in various ways. One way of introducing functional groups is to react the polymer with a difunctional compound that has a first functional group that can react with the starting polymer, and a second, heteroatom-containing functional group which forms the site through which crosslinking can occur.

Example of such difunctional compounds include “ene” reagents such as triazolinediones or dichloromaleimide, which are substituted with a heteroatom-containing group as described above. Such reagents react with olefinic groups in the starting polymer to introduce a moiety that contains the heteroatom-containing functional group.

Another type of difunctional compound is one which is readily alkylated in a Freidel-Crafts alkylation and which is substituted with a heteroatom-containing functional group. This type of compound can react with the starting polymer in a Freidel-Crafts alkylation reaction to introduce the functional group. Phenolic or bisphenolic compounds are notable examples of this type of difunctional compound. Once the phenolic or bisphenolic compound becomes alkylated (in a manner analogous that described before), the phenolic OH group itself can act as the heteroatom-containing functional group. Phenolic OH groups can be cured with epoxides, isocyanates and other crosslinking agents. Alternatively, the phenolic OH can be functionalized to introduce other types of heteroatom-containing functional groups. For instance, reaction of phenolic OH groups with epichlorohydrin gives an epoxide group, which can be used to form the crosslink. The phenolic OH can be reacted with a diisocyanate to introduce free isocyanate groups to the starting polymer, or with a dicarboxylic acid (or anhydride) to introduce carboxylic acid groups.

Siloxanes having at least one ethylenically unsaturated substituent and one or more hydrolyzable substituents can be grafted onto the starting polymer using methods analogous to those described, for example, in U.S. Pat. Nos. 5,266,627 and 6,005,055 and WO 02/12354 and WO 02/12355, in order to introduce curable siloxane groups. Examples of ethylenically unsaturated substituent groups include vinyl, allyl, isopropenyl, butenyl, cyclohexenyl and y-(meth)acryloxy allyl groups. Hydrolyzable groups include methoxy, ethoxy, formyloxy, acetoxy, propionyloxy, and alkyl- or arylamino groups. Vinyltrialkoxysilanes such as vinyltriethyoxysilane and vinyltrimethyoxysilane are preferred silane compounds; the modified starting polymers in such cases contain triethoxysilane and trimethoxysilane groups, respectively.

Hydroxyl functionality can also be introduced into the starting polymer though hydroformylation followed by reduction of the resulting aldehyde groups to hydroxyl groups. The hydroformylation can be conducted using a cobalt, nickel or rhodium catalyst, and the reduction of the formyl group can be done catalytically or chemically. Processes of this type are described in U.S. Pat. Nos. 4,216,343; 4,216,344; 4,304,945 and 4,229,562 and in particular U.S. Pat. No. 4,083,816. As before, the resulting hydroxyl groups can function as a site where crosslinking occurs, or can be further modified to introduce other, more reactive functional groups such as epoxide, isocyanate, amine or carboxylic acid groups.

Starting polymers that contain heteroatom-containing functional groups in some cases can be crosslinked by addition of a coreactant during the melt-processing step. The coreactant contains coreactive groups that react with the functional groups on the starting polymer to form covalent bonds thereto. The type of coreactant will of course depend on the particular functional groups that are present on the starting polymer. Starting polymers containing hydroxyl groups can be crosslinked using a polyisocyanate, a dicarboxylic acid or a carboxylic acid anhydride as a coreactant. Starting polymers containing isocyanate groups can be crosslinked using water, polyol compounds, polyamine compounds, aminoalcohols, and polyepoxides as the coreagent. Starting polymers containing epoxide groups can be crosslinked using polyisocyanates, polyamines and bisphenolic compounds as the coreactant. Starting polymers containing amino groups can be crosslinked using polyepoxides or polyisocyanates.

When the starting polymer contains hydrolyzable silane groups, water is a suitable crosslinking agent. Typically, a catalyst is used in conjunction with water in order to promote the curing reaction. Examples of such catalysts are organic bases, carboxylic acids, and organometallic compounds such as organic titanates and complexes or carboxylates of lead, cobalt, iron, nickel, tin or zinc. Specific examples of such catalysts are dibutyltin dilaurate, dioctyltinmaleate, dibutyltindiacetate, dibutyltindioctoate, stannous acetate, stannous octoate, lead naphthenate, zinc caprylate and cobalt naphthenate. Polysubstituted aromatic sulfonic acids as described in WO 2006/017391 are also useful. In order to prevent premature crosslinking, the water or catalyst, or both, may be encapsulated in a shell that releases the material only within the temperature ranges described before.

It is also possible to crosslink the starting polymer by introducing a first type of functional group onto a portion of the starting polymer, and introducing a coreactive functional group onto another portion of the starting polymer. Upon melt blending the two portions of starting polymer, the functional groups react with each other to crosslink the polymer. For example, one portion of the starting polymer may be modified to contain polyisocyanate groups, whereas another portion of the starting polymer may be modified to contain hydroxyl groups. Upon melt blending, urethane bonds will form and crosslink the polymer. Other pairs of coreactive functional groups as described before can be introduced onto separate portions of the starting polymer. Examples of other functional group/coreactive functional group pairs include amines/epoxides, phenolic groups/epoxides; amines/isocyanates, phenolic groups/isocyanates, epoxides/isocyanates, hydroxyl/carboxylic acid and the like.

It is also possible, via analogous strategies, to crosslink the starting polymer with a second polymer to form various polymer blends. The second polymer may be of virtually any type, provided that it can be crosslinked with the starting polymer through one or more of the foregoing mechanisms. The second polymer may be, for example, a polymer of another cyclic olefin; a different polymer or copolymer of dicyclopentadiene; an epoxy resin; a polyether; a polyester; a polycarbonate; a polyolefin; an acrylic or acrylate polymer; a poly(vinyl aromatic) polymer or copolymer; a vinyl ester; a polyacrylonitrile; a polyvinyl alcohol; a poly(vinylidene chloride); a fluoropolymer; a natural or synthetic rubber; a polysulfone; or a different type of polymer. If necessary, the second polymer may be modified to introduce functional groups which act as site through which it can be crosslinked with the starting polymer.

The crosslinking step is conveniently performed by melt-processing the starting polymer under conditions, including the presence of the crosslinking agent if necessary, sufficient to form crosslinks between the polymer chains and produce a product that is at least partially insoluble. The gel (non-extractable) content of the crosslinked polymer is preferably at least 30%, more preferably at least 70%, and especially at least 95% by weight.

A suitable crosslinking method is a reactive extrusion method. In the reactive extrusion method, the starting polymer is introduced into the barrel of an extruder and melted. If necessary, the crosslinking agent is introduced into the extruder. Depending on the nature of the crosslinking agent, it may be, for example, dry blended into the starting polymer, introduced into the extruder through a separate hopper, pumped under pressure into the extruder, or introduced as a masterbatch in a portion of the starting polymer or another polymer or carrier.

The molten mass in the extruder must in most cases exit the extruder before the polymer becomes so crosslinked that it can no longer be formed into a shaped part. If desired, the molten mass can be extruded through a die to form a sheet, film or other article of constant cross-section. The mass can be discharged from the extruder into a mold where it can be formed. Heat can be applied to the extruded or molded mass to continue the crosslinking reaction and produce a thermoset polymer.

The crosslinking step can also be incorporated into an injection molding process, where the starting polymer is melted, mixed if necessary with the crosslinking agent, and injected into a closed mold where the crosslinking reaction proceeds.

The crosslinking step can also be incorporated into processes such as resin transfer molding, reaction injection molding, sheet molding compound (SMC) processes or bulk molding compound (BMC) processes. In these processes, it is often desirable that the viscosity of the starting polymer is somewhat low. Lower molecular weight starting polymers are therefore preferred in these types of processes. It may be necessary to use measures to reduce the viscosity of the starting polymer, such as using higher processing temperatures or a diluent.

The starting polymer can also be crosslinked in solution, in an analogous manner. This approach may be preferable in certain applications, such as the production of electrical laminates.

The properties of the crosslinked polymer will depend in large part on the crosslink density that is produced. The molecular weight of the starting polymer can have a very substantial influence on the crosslink density of the final polymer. Lower molecular weight starting polymers often form more highly crosslinked products with a small molecular weight between crosslinks. Those highly crosslinked polymers tend to be hard and often are somewhat brittle. A lower crosslink density is often produced when the starting polymer has a higher molecular weight. This tends to lead to softer, tougher polymers.

The following examples are provided to illustrate the invention, but are not intended to limit the scope thereof All parts and percentages are by weight unless otherwise indicated.

### EXAMPLE 1

A polymerization vial is maintained under dry nitrogen in a drybox. The vial is charged with 209 mg (0.61 mmol) of WOCl₄ and 50 mL of toluene. A deep red color is produced after stirring for 10 minutes. 2.237 mL (12.25 mmol) of diallyldimethylsilane is added and stirred in for 5 minutes. 50 mL of a 1.69 M solution of dicyclopentadiene in toluene (84.5 mmol dicyclopentadiene) is then added, and the vial is stirred for 4 hours. The vial is then removed from the dry box and 20 mL of a 2% NaOH/MeOH solution is added. The resulting solution is stirred overnight, placed in a separatory funnel and washed four times with 100 mL of water. The solution is then concentrated to 75 mL on a rotary evaporator. 200 mL of methanol is added and the mixture stirred vigorously for several days to produce a viscous oily polymer. The solvent is decanted and the oil washed 4 times with 40 mL methanol. The product oil is then pumped down on a high vacuum line for several days. Yield is 10.5 g (81.5%) of a nearly odorless white powdery solid having a number average molecular weight of 2,319.

### EXAMPLE 2

Example 1 is repeated, reducing the amount of diallyldimethylsilane to 6.12 mmol. 11.1 g (93.3% yield) of a white powdery solid is obtained. The product has a number average molecular weight of 3,467.

### EXAMPLE 3

Example 1 is again repeated, this time reducing the amount of diallyldimethylsilane to 3.06 mmol. 10.6 g (91.4% yield) of a white powdery solid is obtained. The product has a number average molecular weight of 6,709.

### EXAMPLE 4

A polymerization vial is maintained under dry nitrogen in a drybox. The vial is charged with 105 mg (0.307 mmol) of WOCl₄ and 1.110 mL (6.12 mmol) of diallydimethyl silane, followed by 25 mL of toluene and 25 mL of a 1.69 M solution of dicyclopentadiene in toluene (42 mmol dicyclopentadiene). The vial is stirred for 4 hours, removed from the dry box and 10 mL of a 2% NaOH/MeOH solution is added. 400 mg of a commercially available antioxidant (Irganox™1010, from CIBA Specialty Chemicals) is added. The resulting solution is allowed to overnight, and then placed in a separatory funnel and washed four times with 100 mL of water. 200 mL of methanol is added and the mixture stirred vigorously for one hour to produce a viscous oily polymer. The solvent is decanted and the oily solids are dried under high vacuum line for several hours. The solids are placed on a frit and washed with a solution of the antioxidant in methanol, and then pumped down on a high vacuum line for several days. Yield is 5.1 g (80%) of a nearly odorless white powdery solid having a number average molecular weight of 2,150.

### EXAMPLE 5

200 mg of the polymer from Example 4 is added to a vial in a drybox under a dry nitrogen atmosphere, together with 50 mg of biphenyl bis-sulfonyl azide. 3 mL of dichloromethane are then added, and the solids are dissolved. The volatiles are then removed via vacuum to yield a white solid. The vial is then heated to 70° C, and from 70° C. to 165° C. over 30 minutes. The vial is maintained at 165° C. for one hour, and allowed to cool to 22° C. overnight. The vial contents are taken up in methylene chloride and found to be completely insoluble, indicating that the polymer has become crosslinked.

Similar results are obtained when the polymers from Examples 1, 2 or 3 are crosslinked in a similar manner.

### EXAMPLE 6

200 mg of the polymer from in Example 4 is added to a vial in a drybox under a dry nitrogen atmosphere, together with 50 mg of camphorfuroxan. 3 mL of dichloromethane are then added, and the solids are dissolved. The volatiles are then removed via vacuum to yield an oily solid. The vial is then heated to 110° C., first melting the solids and then hardening them within 5-10 minutes. Heating is continued for about 2 hours to produce a glassy solid which is insoluble in methylene chloride, indicating that the polymer has become crosslinked.

Similar results are obtained when the amount of camphorfuroxan is reduced by half

Similar results are obtained when the polymers from Examples 1, 2 or 3 are crosslinked in a similar manner.

### EXAMPLE 7

200 mg of the polymer from in Example 4 is added to a vial in a drybox under a dry nitrogen atmosphere, together with 100 mg of phenol. The mixture is heated to 80° C., and 12 μL (0.09 mmol) of borontrifluoride-diethyletherate is added. The mixture immediately turns red and increases in viscosity. The vial is then heated to 105° C. for one hour. 10 mL of distilled water is added and the mixture is allowed to sit overnight at room temperature. The mixture is then taken up in 3 mL of toluene and sonicated. The soluble fraction does not show any polymer resonances by NMR spectroscopy, indicating that the polymer has become crosslinked.

Similar results are obtained when the polymers from Examples 1, 2 or 3 are crosslinked in a similar manner.

What is claimed is:

1. A process comprising melting a thermoplastic, solid dicyclopentadiene polymer or copolymer and crosslinking the dicyclopentadiene polymer or copolymer in the melt to form a crosslinked polymer having a gel content of at least 35%.

2. The process of claim 1 wherein the crosslinked polymer has a gel content of at least 95%.

3. A process for preparing a crosslinked dicyclopentadiene polymer or copolymer, comprising (a) forming a reaction mixture containing (1) at least one thermoplastic polymer or copolymer of dicyclopentadiene and (2) at least one crosslinking agent, and (b) subjecting the reaction mixture to conditions sufficient to crosslink the thermoplastic polymer or copolymer.

4. The process of claim 3, wherein the thermoplastic polymer or copolymer of dicyclopentadiene contains no more than 1000 ppm of residual monomers.

5. The process of claim 4, wherein in step a), the reaction mixture is formed by melting the dicyclopentadiene polymer or copolymer and mixing the crosslinking agent into melted dicyclopentadiene polymer or copolymer.

6. The process of claim 5, wherein step a) is conducted in an extruder.

7. The process of claim 5, wherein the reaction mixture from step a) is injection molded and at least a portion of step b) is conducted within a mold.

8. The process of claim 3 which is a resin transfer molding, reaction injection molding, SMC or BMC process.

9. The process of claim 3 wherein the crosslinking agent is at least one of a peroxy compound, an azo compound, a bis-sulfonyl azide, a furoxan, a phenolic or bisphenol, a triazolinedione or a dichloromaleimide.

10. A process for preparing a polydicyclopentadiene polymer or copolymer, comprising subjecting a previously formed, crosslinkable polydicyclopentadiene starting polymer or copolymer having a number average molecular weight of from 1000 to 50,000 to conditions sufficient to crosslink the polydicyclopentadiene polymer.

11. The process of claim 10 wherein the starting polymer or copolymer has a residual monomer content of less than 100 ppm.

12. The process of claim 11, wherein the starting polymer or copolymer contains curable oxygen-containing or nitrogen-containing functional groups.

13. The process of claim 12, wherein the functional groups are isocyanate, carboxylic acid, carboxylic acid anhydride, epoxide, alcohol, triazolinedione, hydrolyzable siloxane or dichloromaleimide groups, are a mixture of two or more of such groups.

14. The process of claim 13 which is conducted in the presence of a crosslinking agent which reacts with the functional groups to form crosslinks.

15. The process of claim 10 which is conducted in the presence of an olefin metathesis or vinyl addition catalyst.

16. A process for preparing a thermoplastic polymer or copolymer of dicyclopentadiene, comprising subjecting dicyclopentadiene monomer or a monomer mixture of dicyclopentadiene and at least one other cyclic olefin, a polymerization catalyst and at least 0.03 moles of a chain transfer agent per mole of monomer or monomers to conditions sufficient to polymerize the monomer or monomers to form a thermoplastic polymer.

17. The process of claim 16, wherein the thermoplastic polymer or copolymer has a gel content of no more than 1% by weight.

18. The process of claim 16, further comprising reducing the residual monomer content of the thermoplastic polymer to no greater than 100 ppm.

19. A process comprising (a) polymerizing dicyclopentadiene to form a thermoplastic polymer having a number average molecular weight of from 1000 to 50,000, (b) reducing the residual monomer content of the polymer to less than 1000 ppm, and then (c) crosslinking the polymer.

20. The process of claim 19 wherein in step (b), the residual monomer content is reduced to no more than 10 ppm.

21. A thermoplastic dicyclopentadiene polymer, wherein the dicyclopentadiene polymer is a homopolymers of dicyclopentadiene or a copolymer of at least 75 mole percent dicyclopentadiene and up to 25 mole percent of at least one other cyclic olefin, the thermoplastic dicyclopentadiene polymer having a number average molecular weight of from 1,000 to 50,000 and a residual monomer content of no more than 100 ppm.
